(19) United States
(12) Patent Application Publication
(10) Pub. No.: US 2010/0180263 A1
(43) Pub. Date: Jul. 15, 2010

(54) APPARATUS AND METHOD FOR DETECTING SOFTWARE ERROR

(76) Inventors: JIN-SEOK LEE, SEOUL (KR); HEE-JIN AHN, SEOUL (KR); HEE-SEOK KIM, SEOUL (KR)

Correspondence Address: North Star Intellectual Property Law, PC, P.O. Box 34688, Washington, DC, 20043, US

(21) Appl. No.: 12/639,592

(22) Filed: Dec. 16, 2009

(30) Foreign Application Priority Data
Jan. 15, 2009 (KR) 10-2009-0003427

(51) Int. Cl. G06F 9/44

(52) U.S. Cl. 717/135

(57) ABSTRACT

An apparatus and method for detecting software error are provided. Trace files are respectively generated by a target machine and a functional simulator that imitates the target machine and performs the same operation as the target machine. Each of the trace files may include at least one of a data-flow-type trace including execution information about one or more instructions and a control-flow-type trace representing information about a part in which a change in address indicating the position of an instruction is a predetermined threshold value or more when the instruction is executed. By comparing the generated trace files, software error may be detected.

### CROSS-REFERENCE TO RELATED APPLICATION

This application claims the benefit under 35 U.S.C. §119(a) of a Korean Patent Application No. 10-2009-3427, filed on Jan. 15, 2009 in the Korean Intellectual Property Office, the entire disclosure of which is incorporated herein by reference for all purposes.

### BACKGROUND

1. Field

The following description relates to a data processing system, and more particularly, to an apparatus and method for detecting software error.

2. Description of the Related Art

An embedded system denotes an apparatus that has a built-in microprocessor or microcontroller and performs functions designated by its designer. Such embedded systems are being applied to various application fields, such as robotics including factory automation, home automation, and robot control. Such embedded systems are being applied to various terminal devices including cellular phones, personal digital assistants (PDAs), and smartphones. Such embedded devices are also being applied to information appliances and network devices including printers, Internet refrigerators, and high-definition televisions (HDTVs), and exchangers, routers, and home servers, respectively.

Hardware of embedded computer systems is improving in performance, and various electronic products are being fused together. Due to these tendencies, the complexity of embedded software is gradually increasing. For this reason, an error that a software developer cannot recognize may occur in actual hardware of a target machine.

To debug such an error, a breakpoint may be set as in a general personal computer environment, and the operation state of software may be checked at a specific point in time. However, in this static method, it is difficult to know data or control flow of the overall software. Also, when the software is finished, it is difficult for its developer to detect the position of an error and debug the error even if a result is abnormal.

The concept of a “trace,” which records a software execution state occurring in embedded systems during a runtime, has been introduced. A trace is a file containing software execution flow and all executed instructions. Using a trace, a developer can recognize software execution flow and a process in which data is changed and detect a software error more accurately. However, it is not easy to analyze and understand a large amount of traces generated in real time, detect the position of an error, and correct the error.

### SUMMARY

According to one general aspect, there is provided an apparatus for detecting software error, including a functional simulator that receives a source code, simulates one or more operations corresponding to a target machine, and generates a simulation trace representing the simulated operation, and a trace comparator that receives a target machine trace generated by the target machine as a result of executing the source code, compares the simulation trace with the target machine trace, and detects an error from the simulation trace in which a trace part of the simulation trace and the target machine trace are not the same.

The trace comparator may manage an exclusion function list that includes one or more functions not performed by the functional simulator among functions performed by the target machine.

The trace comparator may exclude a trace part that is generated by executing a function included in the exclusion function list, from the target machine trace, and compare the target machine trace excluding the trace part with the simulation trace.

The target machine trace may include identification information for identifying functions used by respective trace units to generate the trace, and the trace comparator may exclude a trace unit from the target machine trace, wherein the trace unit has identification information corresponding to identification information of the function included in the exclusion function list.

The identification information may be a function name.

Each of the simulation trace and the target machine trace may include at least one of a to data-flow-type trace including execution information about all instructions and a control-flow-type trace representing a part in which a change in address indicating a position of an instruction is a predetermined threshold value or more when the instruction is executed.

A trace unit of the data-flow-type trace may include an instruction execution cycle time, an instruction, an address of an operand, and the operand.

A trace unit of the control-flow-type trace may include a branch address and a target address of the part in which a change in address indicating a position of an instruction is the predetermined threshold value or more when the instruction is executed.

The trace comparator may first compare the control-flow-type simulation trace with the control-flow-type target machine trace, and then compare the data-flow-type simulation trace with the data-flow-type target machine trace with respect to a part in which the control-flow-type simulation trace and the control-flow-type target machine trace are not the same.

According to another general aspect, there is provided a method of detecting software error, including receiving a source code and generating a simulation trace representing a process of simulating one or more operations corresponding to a target machine, receiving from the target machine a target machine trace representing a process of executing the source code, comparing the simulation trace with the target machine trace, and detecting an error in the simulation trace in which a trace part in the simulation trace and the target machine trace are not the same.

The comparing of the simulation trace with the target machine trace may include excluding a trace part from the target machine trace, wherein the trace part is generated by executing a function included in an exclusion function list of operations that are not performed by a functional simulator among operations that are performed by the target machine, and comparing the target machine trace excluding the trace part with the simulation trace.

The target machine trace may include identification information for identifying functions to used by respective trace units to generate the trace, and the excluding of the trace part may include excluding a trace unit from the target machine, wherein the excluded trace unit has identification information corresponding to identification information of the function included in the exclusion function list.

The identification information may be a function name.

Each of the simulation trace and the target machine trace may include at least one of a data-flow-type trace including execution information about all instructions and a control-flow-type trace representing a part in which a change in address indicating a position of an instruction is a predetermined threshold value or more when the instruction is executed.

A trace unit of the data-flow-type trace may include an instruction execution cycle time, an instruction, an address of an operand, and the operand.

A trace unit of the control-flow-type trace may include a branch address and a target address of the part in which a change in address indicating a position of an instruction is the predetermined threshold value or more when the instruction is executed.

The comparing of the simulation trace with the target machine trace may include comparing the control-flow-type simulation trace with the control-flow-type target machine trace, and comparing the data-flow-type simulation trace with the data-flow-type target machine trace with respect to a part in which the control-flow-type simulation trace and the control-flow-type target machine trace are not the same.

Other features and aspects will be apparent from the following description, the drawings, and the claims.

### BRIEF DESCRIPTION OF THE DRAWINGS

FIG. 1 is a block diagram of an exemplary apparatus for detecting software error.

FIG. 2 is a flowchart illustrating an exemplary method of detecting software error.

FIG. 3 is a flowchart illustrating an exemplary method of comparing traces that is used in the method of detecting software error in FIG. 2.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses, and/or methods described herein will be suggested to those of ordinary skill in the art. Also, descriptions of well-known functions and constructions may be omitted for increased clarity and conciseness.

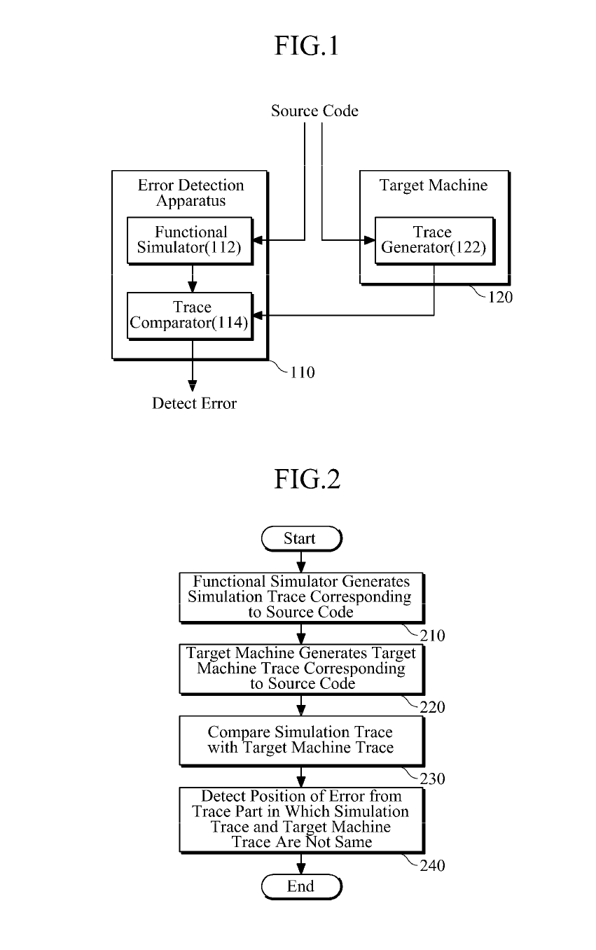

FIG. 1 illustrates an exemplary apparatus for detecting software error.

FIG. 1 shows an error detection apparatus 110 for detecting software error according to an exemplary embodiment, and a target machine 120. The error detection apparatus 110 detects a software error executed in the target machine 120. The software may be embedded software. The target machine 120 may be one of various processors or controllers.

The target machine 120 may include a trace generator 122 that generates a trace representing an instruction execution process. In general, the target machine 120 may include a dedicated trace port, and the trace may be output from the dedicated trace port. The error detection apparatus 110 receives the trace output from the target machine 120. The error detection apparatus 110 and the target machine 120 are shown separately in FIG. 1, but may be integrated.

The error detection apparatus 110 may generate a trace using a functional simulator 112 that performs the same operations as the target machine 120. The functional simulator 112 imitates the target machine 120. The error detection apparatus 110 may compare the trace generated by the target machine 120 with the trace file generated by the functional simulator 112. A part in which the traces are not the same may be detected as a part in which a non-expected runtime error is caused by the functional simulator 112 imitating the operation of the target machine 120.

In the following description, a trace generated by the target machine 120 will be referred to as a target machine trace, and a trace generated by the functional simulator 112 will be referred to as a simulation trace.

The simulation trace may have one or more formats and the target machine trace may have one or more formats. A data-flow-type trace includes execution information about all instructions. A data-flow-type trace unit may include an instruction execution cycle time (cycle), an execution instruction (e.g., opcode), the address of an operand, and/or the operand. An operand denotes data to be processed by an instruction, and the address of an operand may be the address of a memory or the number of a register storing the operand.

A control-flow-type trace represents information about a part in which a change in address indicating the position of an instruction is a predetermined threshold value or more when the instruction is executed. The trace unit of a control flow trace may include the branch address (or source address) and target address of a part in which a change in address indicating the position of an instruction is a predetermined threshold value or more when the instruction is executed. Referring to FIG. 1, the error detection apparatus 110 includes the functional simulator 112 and a trace comparator 114.

The functional simulator 112 receives a source code, simulates one or more operations corresponding to the target machine 120, and generates a trace representing the simulated operation. As described herein, an operation includes one or more functions. The functional simulator 112 is implemented in an imitation of the target machine 120 so that it can be used to verify a logic of software. The source code may be, for example, a binary file generated by is compiling the software.

The trace comparator 114 may receive a target machine trace generated by the target machine 120 as a result of executing the source code. The trace comparator 114 may compare the simulation trace with the target machine trace. The trace comparator 114 may detect a trace part in which the simulation trace is not the same as the target machine trace, and the trace comparator 114 may identify the trace part as a part in which an error occurs.

In the target machine 120, a function, for example, an interrupt processing function or a hardware processing function, may be repeatedly executed. In some embodiments, a function may be executed at a different cycle from the functional simulator 112. When a function is executed at a different cycle from the functional simulator 112, the functional simulator 112 may be designed to perform a next instruction on the assumption that it has actually performed operation of the target machine 120, rather than an imitation of the target machine 120.

For those functions where the functional simulator 112 functions different from the target machine 120, the trace comparator 114 may manage an exclusion function list that includes a list of one or more functions denoting operations not performed by the functional simulator 112 among operations that are performed by the target machine 120. The exclusion function list includes information describing a function not relating to the logic of software. In other words, the exclusion function list may be a list of functions that are executed in the target machine 120 but not actually executed and merely assumed to be executed in the functional simulator 112.

The exclusion function list may be generated and stored in advance by a user. The exclusion function list may be changed or amended after it has been generated and stored. The exclusion function list may be written in various forms such as a text document or an extensible markup language (XML) document.

For example, the target machine 120 executes a function of waiting until a direct memory is access (DMA) operation is finished, but the functional simulator 112 performs operation for a next instruction on the assumption that the DMA operation is finished. In this example, trace units not included in the simulation trace will be included in the target machine trace. The trace comparator 114 removes trace units from the target machine trace which are generated by executing a function included in the above-described exclusion function list, and then compares the residual target machine trace with the trace units removed, to the simulation trace.

Identification information for identifying functions used to generate the target machine trace may be included in respective trace units of the target machine trace. Here, the identification information may be function names. The function names can be used as identification information.

When the trace comparator 114 compares the simulation trace with the target machine trace according to trace units, a trace unit having identification information corresponding to the identification information of a function included in the exclusion function list may be detected from the target machine trace. The trace comparator 114 may exclude the trace unit, and then compare the next trace units.

Because a trace includes information varying according to the type of the trace, the trace comparison operation of the trace comparator 114 varies according to the type of the trace.

When the trace comparator 114 compares control-flow-type traces generated by the functional simulator 112 and the target machine 120, the comparison operation is performed for an instruction where a branch at which the address of the instruction is changed by a predetermined threshold value or more is generated among entire instructions, and thus it can be verified in a relatively short time whether or not there is a software error. However, only parts of the simulation trace and the target machine trace in which a branch is generated are compared with each other. Thus, when an error occurs in the process of executing the other instructions, is the error may not be detected.

When data-flow-type traces are generated by the functional simulator 112 and the target machine 120, the generated data-flow-type traces can be compared. When data-flow-type traces are compared, results of executing the instructions to execute software, that is, instruction execution cycles, the instructions, the addresses of the instructions, operands, the addresses of the operands (source operand address and target operand address), etc., are compared, and an error may be detected. Also, when data-flow-type traces are compared, an instruction influencing a part in which an error is detected is searched for using a definition-use (DU) chain of a compiler (not shown), and the position of a trace unit in which the data-flow-type traces are not the same may be found in the source code. When the amounts of compared traces are large, it may take more time to compare data-flow-type traces than control-flow-type traces.

According to an exemplary embodiment, the trace comparator 114 may first compare a control-flow-type simulation trace with a control-flow-type target machine trace and a part in which an error occurs may be detected. The trace comparator 114 may compare a data-flow-type simulation trace with a data-flow-type target machine trace with respect to the part in which an error is detected according to the result of the first comparison operation. For example, a data-flow-type simulation trace and a data-flow-type target machine trace may be compared, beginning with a point in which an error is detected by comparing a control-flow-type simulation trace with a control-flow-type target machine trace.

As described above, according to an exemplary embodiment, a simulation trace and a target machine trace may be compared, and a trace unit in which the simulation trace is different from the target machine trace may be detected and identified as a position in which an error occurs. Thus, it is possible to efficiently detect an error from a large amount of traces generated by a target machine as a result of executing software.

FIG. 2 illustrates an exemplary method of detecting software error.

A functional simulator receives a source code and generates a simulation trace representing a process of simulating operations corresponding to a target machine 210.

The target machine receives the source code and generates a target machine trace representing a process of executing the source code 220. The generating the simulation trace 210 and the generating the target machine trace 220 may be performed simultaneously or they may be performed at different times.

The functional simulator and the target machine can generate at least one type of trace among the data-flow-type trace and the control-flow-type trace. The data-flow-type trace may include execution information about instructions and the control-flow-type trace may include information about a part in which a change in address indicating the position of an instruction is a predetermined threshold value or more when the instruction is executed. A data flow trace may include an instruction execution cycle time, an instruction, the address of an operand, and the operand. A control flow trace may include address information, that is, the branch address and target address of a part in which a change in address indicating the position of an instruction is a predetermined threshold value or more when the instruction is executed.

The simulation trace and target machine trace are compared in 230. The comparison of the simulation trace and the target machine trace may include, a first comparison of a control-flow-type simulation trace and a control-flow-type target machine, and then a data-flow-type simulation trace and a data-flow-type target machine trace may be compared with respect to a part in which the control-flow-type traces are not the same.

A trace part in which traces are not the same may be detected as a part in which an error occurs so that the position of the error can be detected in 240.

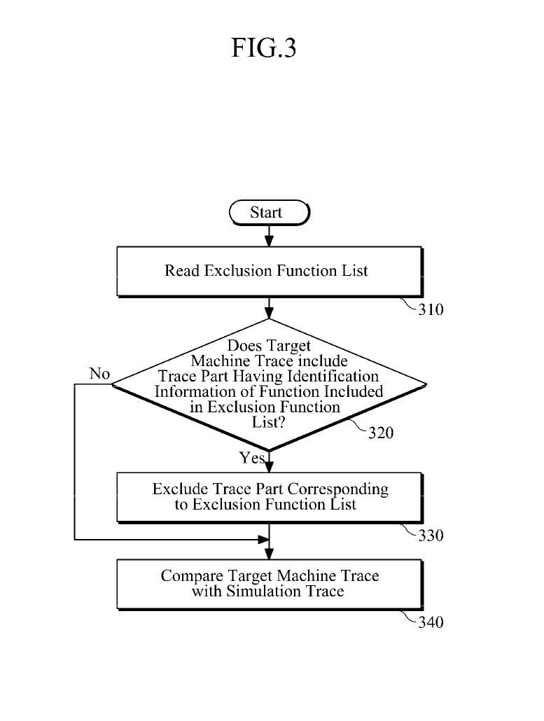

FIG. 3 illustrates an exemplary method of comparing traces that is used in a method of detecting software error.

At least one exclusion function list is read in 310. The exclusion function list includes is functions that are not performed by a functional simulator among operations that are performed by a target machine. The exclusion function list may be set and stored in an error detection apparatus in advance. After storage, the exclusion function list can be amended to add or remove functions from the list.

In 320, the target machine trace is checked to determine whether a target machine trace includes a trace part generated by executing a function included in the exclusion function list.

The trace part generated by executing the function included in the exclusion function list is excluded from the target machine trace in 330. When the target machine trace includes identification information for identifying functions used by respective trace units, a trace unit having identification information corresponding to identification information of the function included in the exclusion function list may be excluded from the target machine trace. The identification information may be a function name.

The target machine trace excluding the trace unit is compared with a simulation trace in 340.

In FIG. 3, excluding the result of executing the function included in the exclusion function list from the target machine trace 330 is performed before the comparison operation 340. However, the operations are not required to be performed in sequence. The result of executing the function included in the exclusion function list may be excluded during the comparison operation. In other words, when the identification information of the function included in the exclusion function list is found in the target machine trace while the simulation trace and the target machine trace are compared according to trace units, the corresponding trace unit may be excluded, and then the comparison operation may be continuously performed on the next trace unit.

The methods described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for detecting software error, comprising:
a functional simulator that receives a source code, simulates one or more operations corresponding to a target machine, and generates a simulation trace representing the simulated operation; and
a trace comparator that receives a target machine trace generated by the target machine as a result of executing the source code, compares the simulation trace with the target machine trace, and detects an error from the simulation trace in which a trace part of the simulation trace to and the target machine trace are not the same.

2. The apparatus of claim 1, wherein the trace comparator manages an exclusion function list that includes one or more functions not performed by the functional simulator among functions performed by the target machine.

3. The apparatus of claim 2, wherein the trace comparator excludes a trace part that is generated by executing a function included in the exclusion function list, from the target machine trace, and compares the target machine trace excluding the trace part with the simulation trace.

4. The apparatus of claim 2, wherein the target machine trace includes identification information for identifying functions used by respective trace units to generate the trace, and
the trace comparator excludes a trace unit from the target machine trace, wherein the trace unit has identification information corresponding to identification information of the function included in the exclusion function list.

5. The apparatus of claim 4, wherein the identification information is a function name.

6. The apparatus of claim 1, wherein each of the simulation trace and the target machine trace includes at least one of a data-flow-type trace including execution information about all instructions and a control-flow-type trace representing a part in which a change in address indicating a position of an instruction is a predetermined threshold value or more when the instruction is executed.

7. The apparatus of claim 6, wherein a trace unit of the data-flow-type trace includes an instruction execution cycle time, an instruction, an address of an operand, and the operand.

8. The apparatus of claim 6, wherein a trace unit of the control-flow-type trace includes a branch address and a target address of the part in which a change in address indicating is a position of an instruction is the predetermined threshold value or more when the instruction is executed.

9. The apparatus of claim 6, wherein the trace comparator first compares the control-flow-type simulation trace with the control-flow-type target machine trace, and then compares the data-flow-type simulation trace with the data-flow-type target machine trace with respect to a part in which the control-flow-type simulation trace and the control-flow-type target machine trace are not the same.

10. A method of detecting software error, comprising:
receiving a source code and generating a simulation trace representing a process of simulating one or more operations corresponding to a target machine;
receiving from the target machine a target machine trace representing a process of executing the source code;
comparing the simulation trace with the target machine trace; and
detecting an error in the simulation trace in which a trace part in the simulation trace and the target machine trace are not the same.

11. The method of claim 10, wherein the comparing of the simulation trace with the target machine trace includes:
excluding a trace part from the target machine trace, wherein the trace part is generated by executing a function included in an exclusion function list of operations that are not performed by a functional simulator among operations that are performed by the target machine; and
comparing the target machine trace excluding the trace part with the simulation trace.

12. The method of claim 11, wherein the target machine trace includes identification information for identifying functions used by respective trace units to generate the trace, and
the excluding of the trace part includes excluding a trace unit from the target machine, wherein the excluded trace unit has identification information corresponding to identification information of the function included in the exclusion function list.

13. The method of claim 12, wherein the identification information is a function name.

14. The method of claim 10, wherein each of the simulation trace and the target machine trace includes at least one of a data-flow-type trace including execution information about all instructions and a control-flow-type trace representing a part in which a change in address indicating a position of an instruction is a predetermined threshold value or more when the instruction is executed.

15. The method of claim 14, wherein a trace unit of the data-flow-type trace includes to an instruction execution cycle time, an instruction, an address of an operand, and the operand.

16. The method of claim 14, wherein a trace unit of the control-flow-type trace includes a branch address and a target address of the part in which a change in address indicating a position of an instruction is the predetermined threshold value or more when the instruction is is executed.

17. The method of claim 14, wherein the comparing of the simulation trace with the target machine trace includes:
comparing the control-flow-type simulation trace with the control-flow-type target machine trace; and
comparing the data-flow-type simulation trace with the data-flow-type target machine trace with respect to a part in which the control-flow-type simulation trace and the control-flow-type target machine trace are not the same.
